(19) United States
(12) Patent Application Publication
(10) Pub. No.: US 2014/0166826 A1
(43) Pub. Date: Jun. 19, 2014

(54) LATCHING MECHANISM AND DISPLAY DEVICE USING THE LATCHING MECHANISM

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventors: WEN-TAO LIAO, Shenzhen (CN); HAN FENG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/972,934

(22) Filed: Aug. 22, 2013

(30) Foreign Application Priority Data
Dec. 17, 2012 (CN) 2012105472194

(51) Int. Cl. F16M 11/04

(52) U.S. Cl. CPC F16M 11/041
USPC 248/158; 403/327

(57) ABSTRACT

A latching mechanism includes a base, a sliding member, a rotary member, and an elastic member. The sliding member can be moved down and up along the base, and includes a first limiting element and a second limiting element. The rotary member is pivotally secured to the base, and includes a first resisting element and a second resisting element. The elastic member is pivotally secured to the base. The elastic member can cause the rotary member to rotate toward different directions. When the rotary member is rotated to cause the first resisting element to be engaged with a bottom of the first limiting element, the latching mechanism is in a locked state. The second limiting element can resist the second resisting element to cause the rotary member to rotate until the first resisting element contacts the first limiting element.

### BACKGROUND

1. Technical Field

The present disclosure relates to latching mechanisms, and particularly to a latching mechanism and a display device using the same.

2. Description of Related Art

A latch is used to join two objects together while allowing for the regular separation of the objects. Usually, for a display latched to a stand, operating the latch will need two hands, which may bring inconvenience to users.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a partial, cross-sectional view of a display device having a latching mechanism, in accordance with an exemplary embodiment.

FIG. 2 is an exploded, perspective view of the latching mechanism of FIG. 1.

FIG. 3 is an isometric view of the latching mechanism of FIG. 2.

FIGS. 4-7 are front views of the latching mechanism of FIG. 3, showing how to cause the latching mechanism to be in a locked state.

FIGS. 8-12 are front views of the latching mechanism of FIG. 3, showing how to cause the latching mechanism to be in an unlocked state.

FIG. 13 is a schematic view showing length relationships between some elements of the latching mechanism of FIG. 3.

### DETAILED DESCRIPTION

Embodiments of the present disclosure are described, with reference to the accompanying drawings.

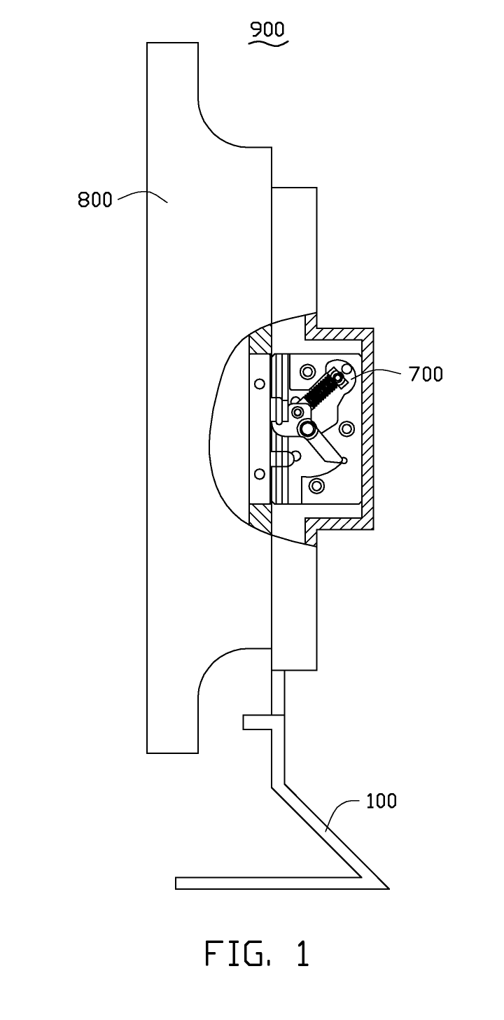

FIG. 1 shows a display device 900 of one embodiment. The display device 900 includes a display 800, a stand 100, and a latching mechanism 700. The display 800 is latched to and detached from the stand 100 via the latching mechanism 700. The latching mechanism 700 is also suitable for doors or windows.

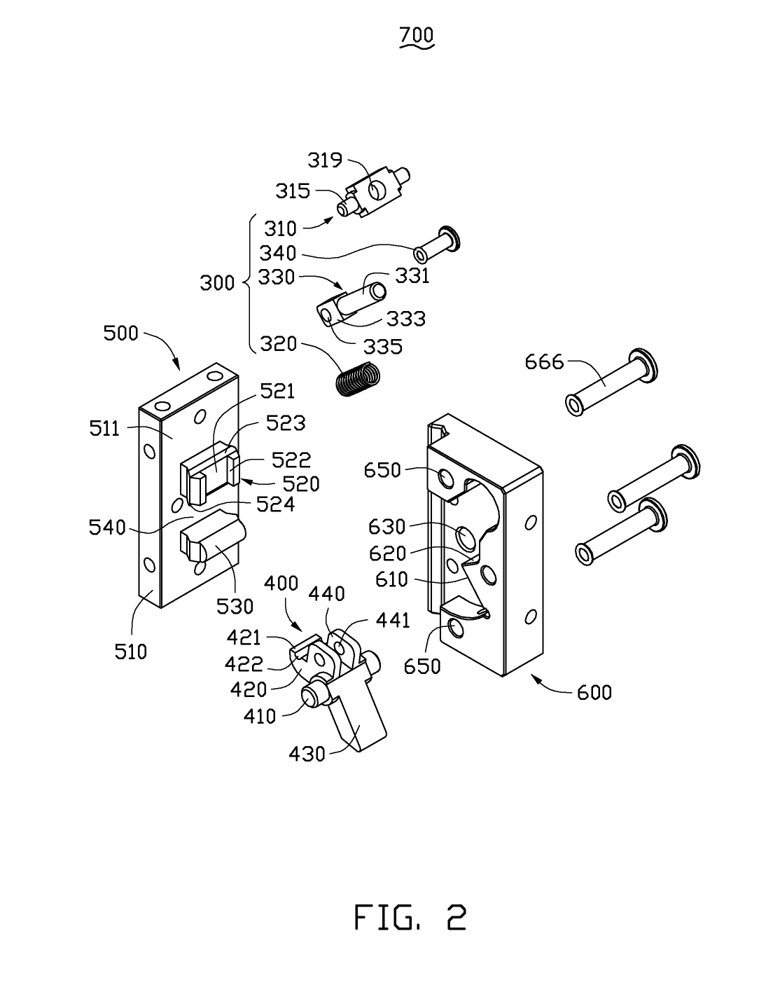

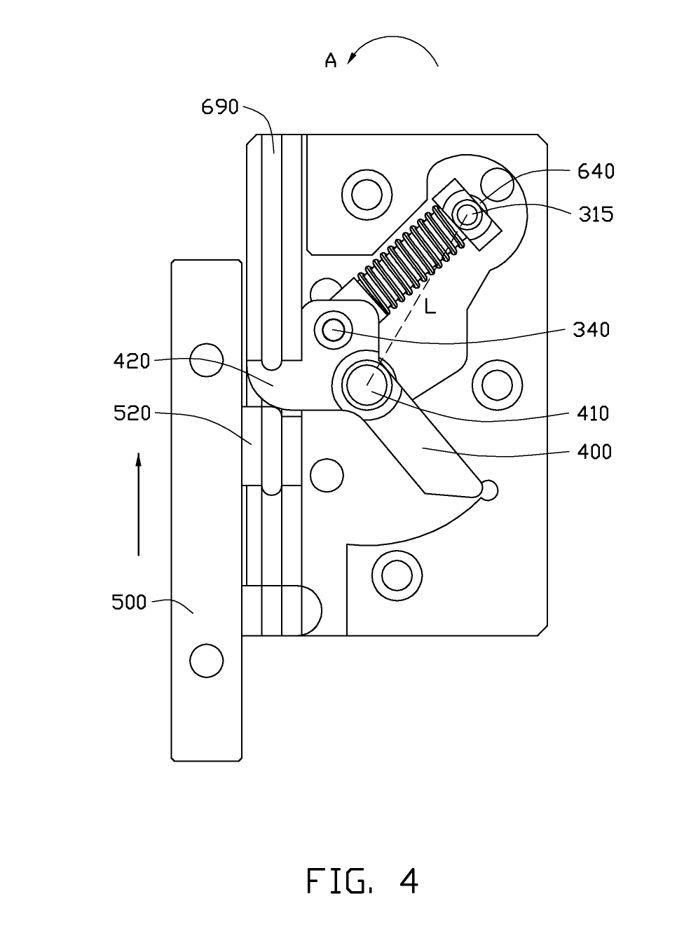

FIGS. 2-4 show that the latching mechanism 700 includes a base 600, a sliding member 500, a rotary member 400, and an elastic member 300. In this embodiment, the sliding member 500 is attached to a back of the display 800. The base 600 is attached to the stand 100. The sliding member 500 can slide up and down along the base 600. The rotary member 400 is pivotally fixed to the base 600. The elastic member 300 can cause the rotary member 400 to rotate toward a first direction (e.g. the A direction shown in FIG. 4) and a second direction opposite to the first direction.

The sliding member 500 includes a main body 510, a first limiting element 520, and a second limiting element 530. The first limiting element 520 and the second limiting element 530 protrude from a front surface 511 of the main body 510 facing the rotary member 400 and are parallel to each other to define a first gap 540. The distance between a free end of the second limiting element 530 and the front surface 511 of the main body 510 is greater than the distance between a free end of the first limiting element 520 and the front surface 511 of the main body 510. The first limiting element 520 includes a fixing portion 523, two protrusions 522, and a hook 524. The fixing portion 523 is fixed to the front surface 511 of the main body 510. The protrusions 522 protrude from the fixing portion 523 and are parallel to each other to cooperatively form a second gap 521. A portion of the rotary member 400 can enter the first gap 540 via the second gap 521. The hook 524 protrudes from a bottom of the fixing portion 523 facing the second limiting element 530.

The rotary member 400 includes a first pivot 410, a first resisting element 420, and a second resisting element 430. The first pivot 410 is pivotally fixed to the base 600. The first resisting element 420 and the second resisting element 430 are arranged on the first pivot 410 and angled to each other. In this embodiment, the angle between the first resisting element 420 and the second resisting element 430 is an obtuse angle. The first resisting element 420 can engage the first limiting element 520 to prevent the sliding member 500 from sliding down. A free end of the first resisting element 420 defines a latching portion 421. The latching portion 421 defines a latching slot 422 to latch the hook 524. The latching slot 422 cooperates with the hook 524 to latch the sliding member 500. Two sidewalls 440 protrude from the first resisting element 420. The sidewalls 440 are parallel to each other and away from the second resisting element 430. Each sidewall 440 defines a latching hole 441 to latch the elastic member 300.

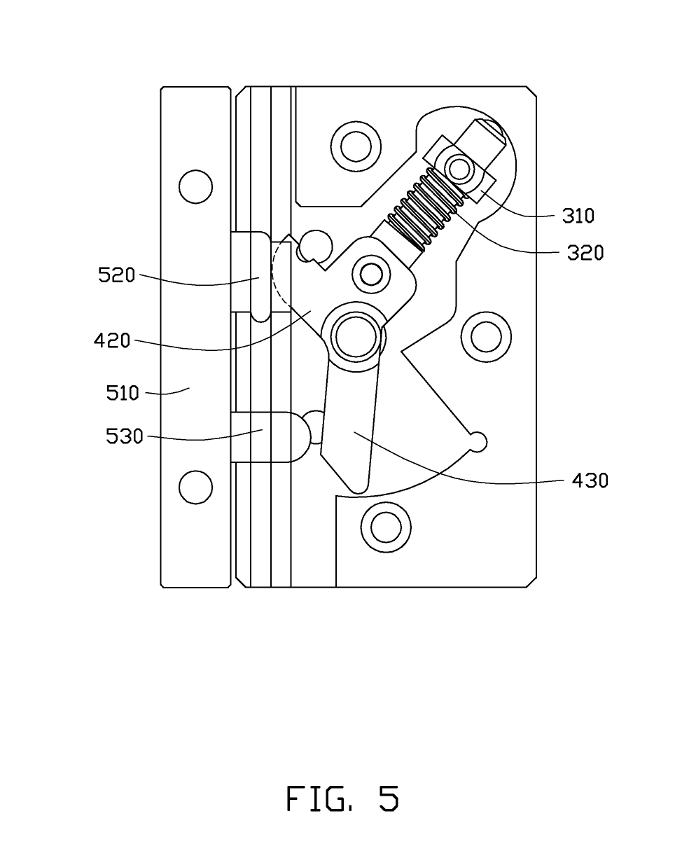

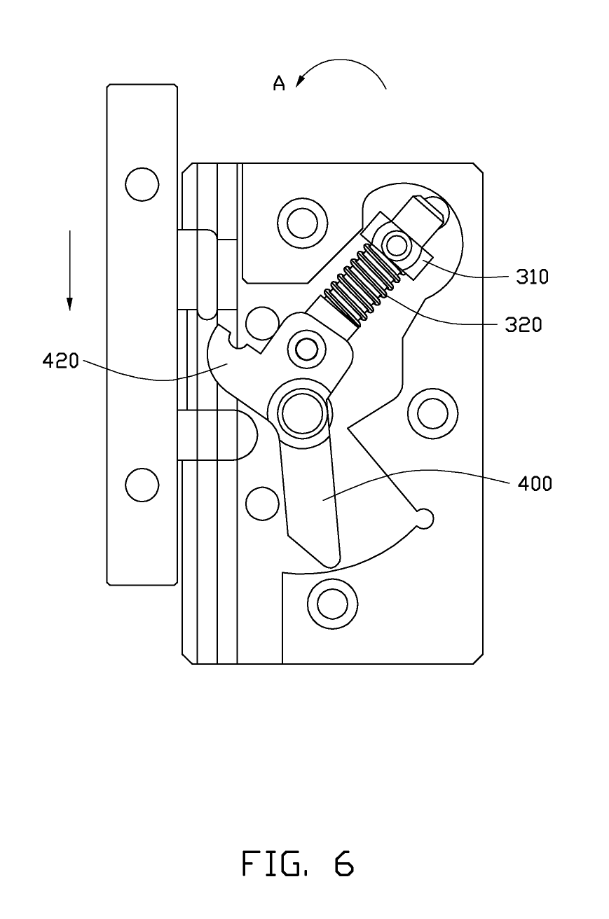

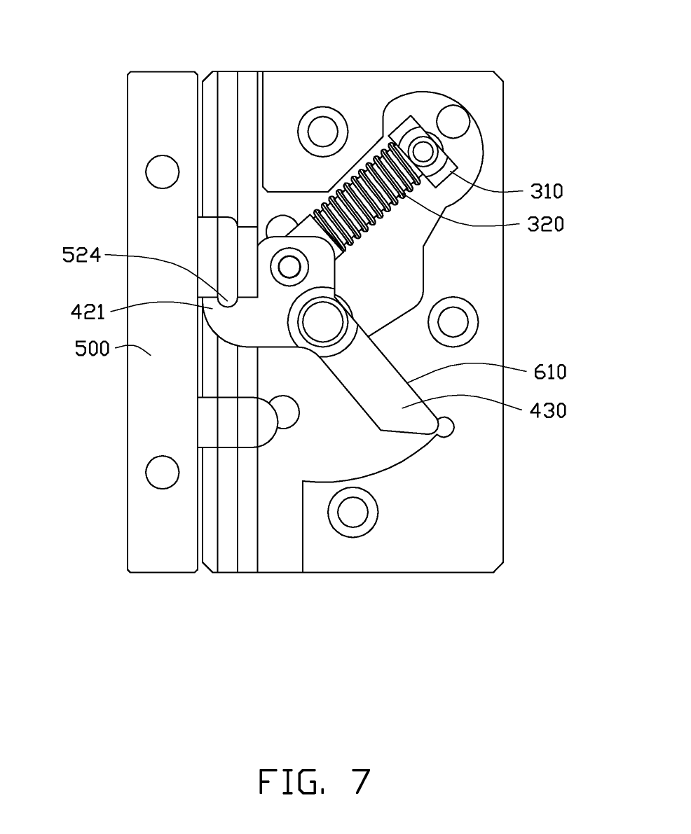

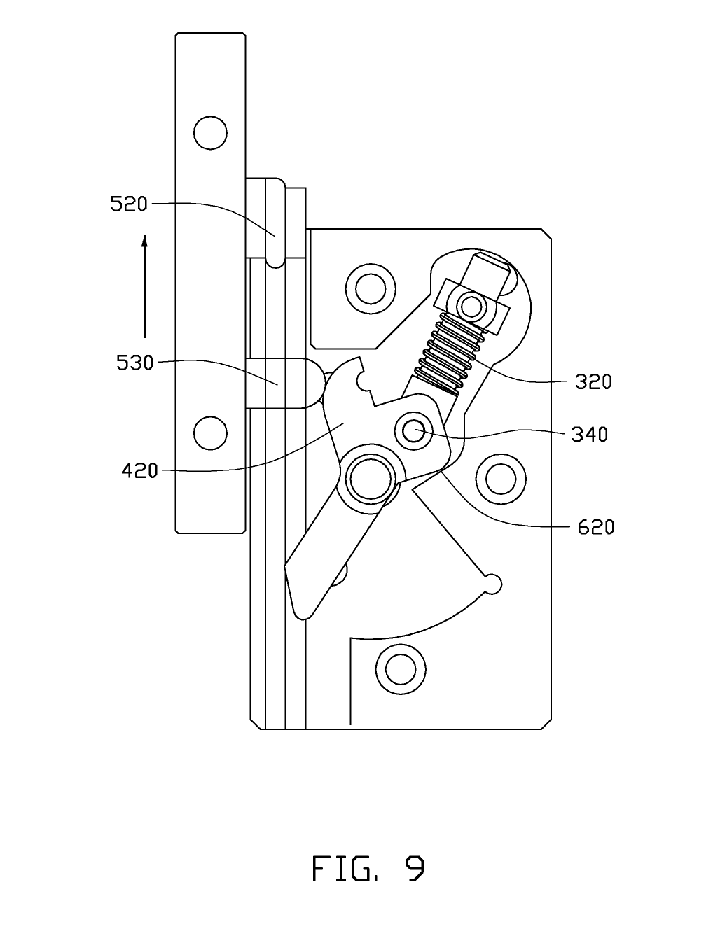

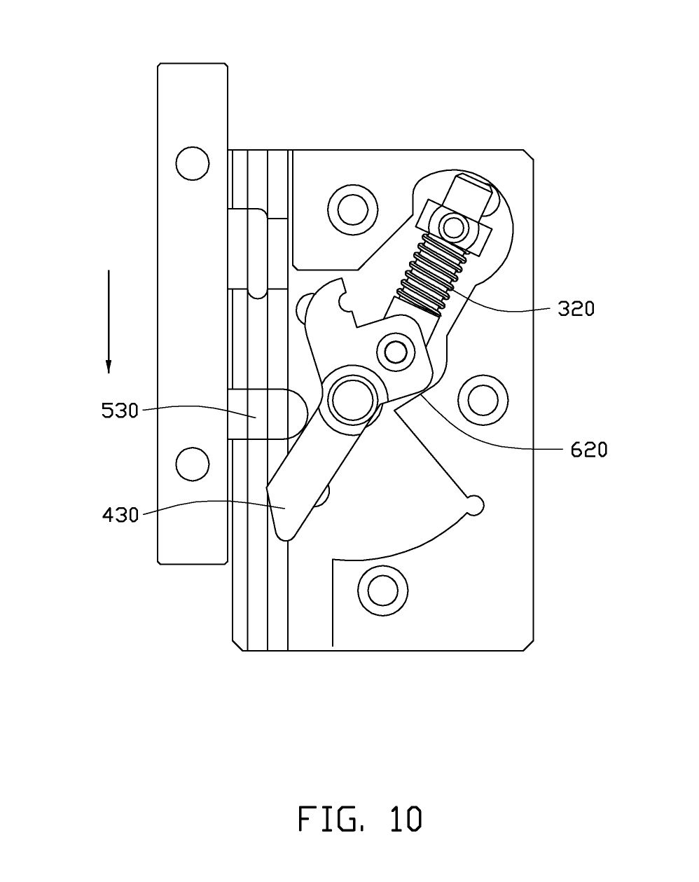

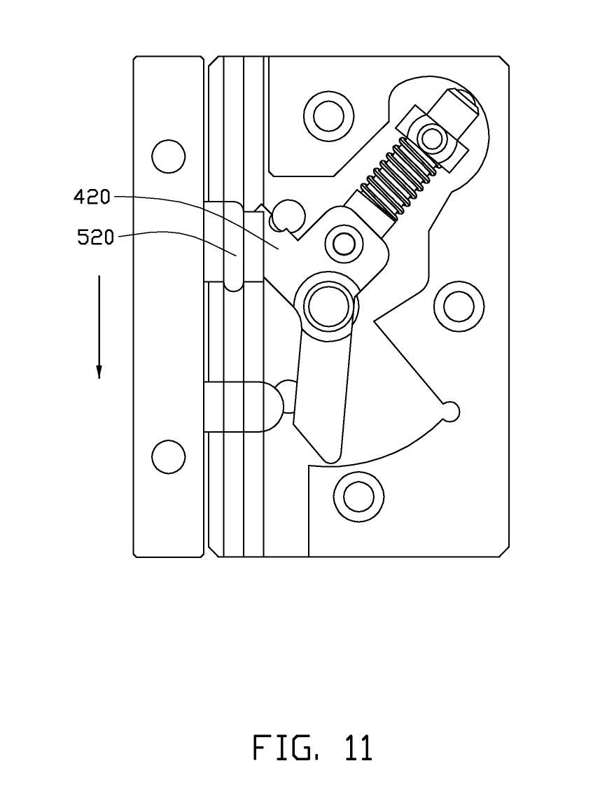

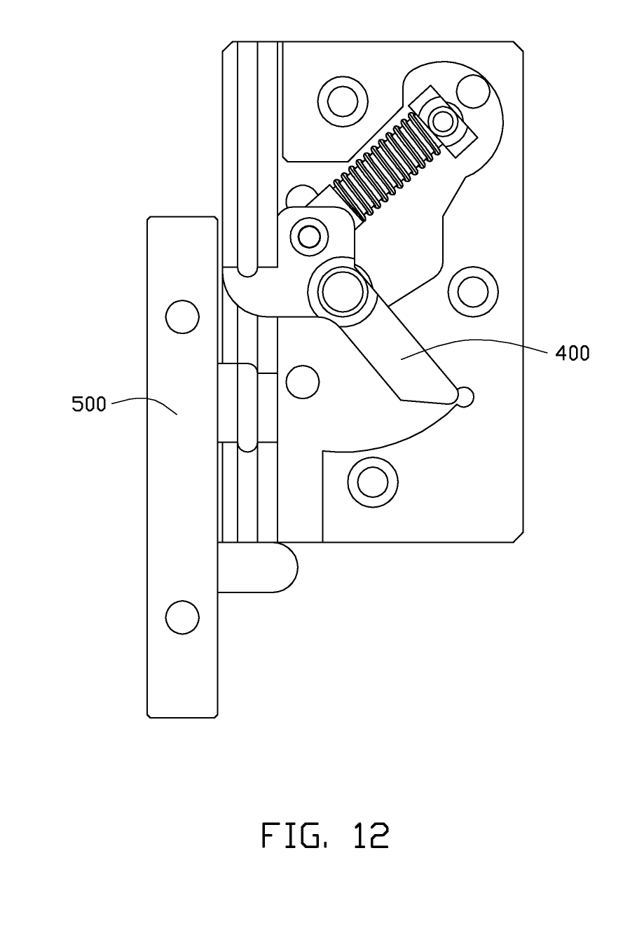

The elastic member 300 includes a fixing element 310, an elastic element 320, a connecting element 330, and a third pivot 340. The fixing element 310 is pivotally fixed to the base 600 and includes a second pivot 315. The fixing element 310 defines a limiting hole 319 to receive a rod 331 of the connecting element 330. The elastic element 320 is arranged over the connecting element 330, with one end resisting a head 333 of the connecting element 330 and an opposite end resisting the fixing element 310. The head 333 defines a latching hole 335. The head 333 is arranged between the sidewalls 440, with the latching holes 441, 335 aligned with each other. The second pivot 340 passes through the latching holes 441, 335 in sequence to pivotally secure the connecting element 330 to the first resisting element 420. In this embodiment, a line L connecting the second pivot 315 and the first pivot 410 is defined as a reference line L (see FIG. 4). When the second pivot 340 is at a left side of the reference line L, the elastic element 320 forces the rotary member 400 to rotate toward the first direction (see FIGS. 4-8 and FIGS. 11-12). When the second pivot 340 is at a right side of the reference line L, the elastic element 320 forces the rotary member 400 to rotate toward the second direction (see FIGS. 9-10).

The base 600 includes a first limiting surface 610 and a second limiting surface 620. The base 600 further defines a first through hole 630, a second through hole 640 (see FIG. 4), and a number of fixing holes 650. A number of connecting bolts 666 cooperate with the fixing holes 650 to fix the base 600 to the stand 100. The first limiting surface 610 is to prevent the rotary member 400 from rotating towards the first direction. The second limiting surface 620 is to prevent the rotary member 400 from rotating towards the second direction. An end of the first pivot 410 is received in the first through hole 630. An end of the second pivot 315 is received in the second through hole 640. The base 600 further defines a sliding slot 690. The sliding member 500 can slide down and up along the sliding slot 690.

FIGS. 4-7 show that in order to latch the display 800 to the stand 100, the sliding member 500 is moved up, and the first limiting element 520 resists the first resisting element 420 to cause the rotary member 400 to rotate toward the first direction around the first pivot 410. The elastic element 320 forces the first resisting element 420 to move from the second gap 521 to the first gap 540. The elastic element 320 further causes the rotary member 400 to rotate toward the first direction until the latching slot 422 latches the hook 524. At this point, the first limiting surface 610 resists the second resisting element 430 to prevent the rotary member 400 from further rotating toward the first direction. Thus, the display 800 is latched to the stand 100 via the latching mechanism 700.

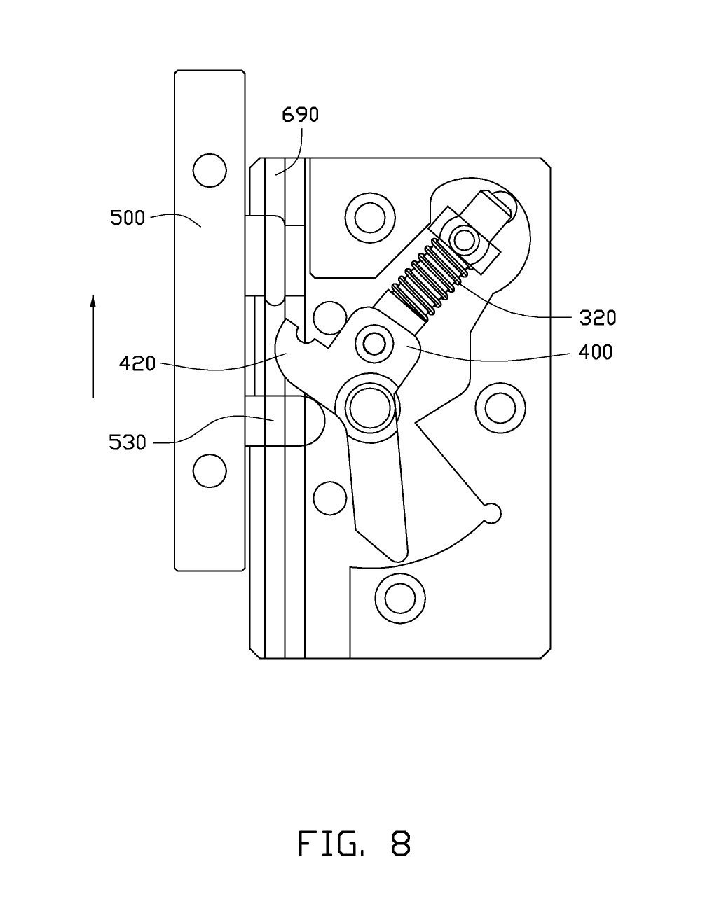

FIGS. 8-12 show that in order to detach the display 800 from the stand 100, the sliding member 500 is moved up, and the second limiting element 530 resists the first resisting element 420 to cause the rotary member 400 to rotate toward the second direction until the third pivot 340 is moved to the right side of the reference line L and the first resisting element 420 resists the second limiting surface 620. At this point, the elastic element 320 forces the rotary member 400 to rotate toward the second direction. As the second limiting surface 620 resists the first resisting element 420, the rotary member 400 stops rotating toward the second direction, and the rotary member 400 is kept in a balanced state. The sliding member 500 is then moved down, and the second limiting element 530 resists the second resisting element 430 to cause the rotary member 400 to rotate toward the first direction. The sliding member 500 is continuously moved down until the first resisting element 420 enters the second gap 521 of the first limiting element 520. The sliding member 500 is continuously moved down until the first resisting element 420 slides out of the second gap 521 and disengages from the first limiting element 520. At this point, the latching mechanism 700 is in an unlocked state, and the display 800 can be detached from the stand 100.

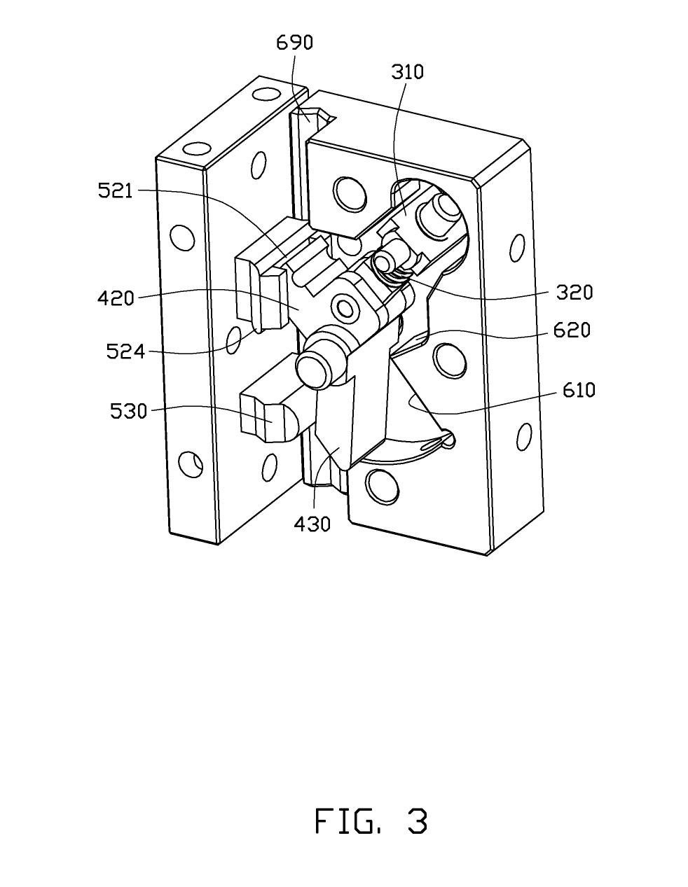

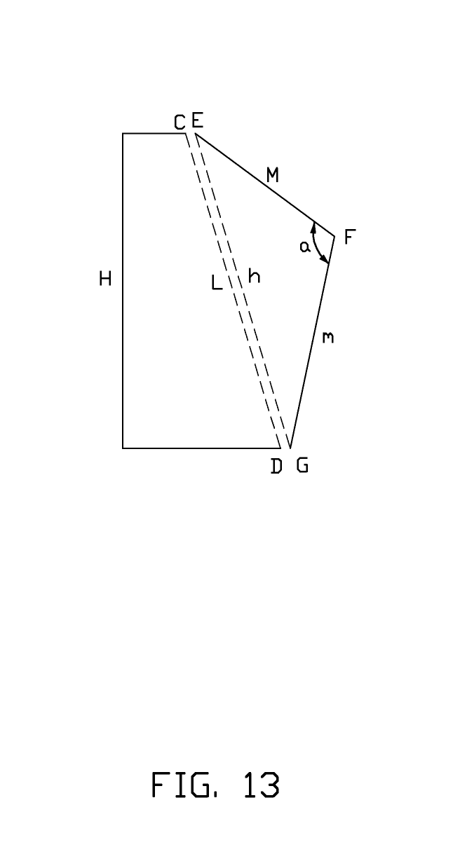

FIG. 13 shows that in order to cause the latching mechanism 700 to be in the unlocked state, the distance H between the first limiting element 520 and the second limiting element 530 should satisfy a preset requirement. Take a surface of the fixing portion 523 away from the main body 510 of the sliding member 500 as a point C, take the free end of the second limiting element 530 as a point D, take a center of the first pivot 410 as a point F, take a free end of the first resisting element 420 as a point E, and take a free end of the second resisting element 430 as a point G. The distance between the points C and D is L, the distance between the points E and G is h, the distance between the points E and F is M, and the distance between the points F and G is m. When the second limiting element 530 resists the second resisting element 430, and the first resisting element 420 is received in the second gap 521 (see FIG. 3), a connection line connecting the points C and D is parallel to the connection line connecting the points E and G. To ensure that the latching mechanism 700 can be switched between the locked state and the unlocked state, L should be less than h. That is, L is related to M, m, and a formed by connection lines connecting the points E, F, and G. Furthermore, H should be less than L.

With such configuration, by sliding the sliding member 500 with one hand, the latching mechanism 700 can be switched between the locked state and the unlocked state.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A latching mechanism comprising:
a base comprising a first limiting surface, a second limiting surface, and a sliding slot;
a sliding member capable of being moved down and up along the sliding slot, and comprising a first limiting element and a second limiting element;
a rotary member comprising a first pivot, a first resisting element, and a second resisting element, wherein, the first pivot is pivotally secured to the base, the first resisting element and the second resisting element are arranged over the first pivot and angled to each other; and
an elastic member with one end pivotally secured to the base and an opposite end pivotally secured to the rotary member, wherein, the elastic member is capable of causing the rotary member to rotate toward a first direction and a second direction opposite to the first direction around the first pivot, the further rotation of the rotary member toward the first direction is prevented by the first limiting surface, and the further rotation of the rotary member toward the second direction is prevented by the second limiting surface;
wherein, when the rotary member is rotated toward the first direction to cause the first resisting element to be engaged with a bottom of the first limiting element, the latching mechanism is in a locked state, and the further rotation of the rotary member toward the first direction is prevented by the first limiting surface, the second limiting element is capable of resisting the first resisting element to cause the rotary member to rotate toward the second direction until the further rotation of the rotary member toward the second direction is prevented by the second limiting surface; the second limiting element is further capable of resisting the second resisting element to cause the rotary member to rotate toward the first direction until the first resisting element contacts the first limiting element, and until the rotary member is in a position where the elastic member causes the rotary member to rotate toward the first direction.

2. The latching mechanism as described in claim 1, wherein the sliding member further comprises a main body, the first limiting element and the second limiting element protrude from a front surface of the main body, the distance between a free end of the second limiting element and the front surface of the main body is greater than the distance between a free end of the second limiting element and the front surface of the main body.

3. The latching mechanism as described in claim 2, wherein the first limiting element and the second limiting element cooperatively form a first gap, the first limiting element includes a fixing portion and two protrusions, the fixing portion is fixed to the main body, the protrusions protrude from the fixing portion and cooperatively form a second gap, an end of the first resisting element enters the first gap via the second gap.

4. The latching mechanism as described in claim 3, wherein a hook protrudes from a bottom of the fixing portion facing the second limiting element, the free end of the first resisting member defines a latching slot to latch the hook.

5. The latching mechanism as described in claim 1, wherein the elastic member comprises a fixing element, a connecting element, and an elastic element, the fixing element comprises a second pivot and is pivotally secured to the base via the second pivot, the elastic element is arranged over the connecting element with one end resisting the fixing element and another end resisting the connecting element.

6. The latching mechanism as described in claim 5, wherein the elastic member further comprises a third pivot, the connecting element is pivotally secured to the rotary member via the third pivot, the third pivot is caused to be rotated around the first pivot.

7. The latching mechanism as described in claim 6, wherein the fixing member defines a limiting hole, one end of the connecting element is slidably received in the limiting hole.

8. The latching mechanism as described in claim 6, wherein when the third pivot is at a left side of a reference line connecting the first pivot and the second pivot, the elastic element forces the rotary member to rotate toward the first direction, and when the third pivot is at a right side of the reference line, the elastic element forces the rotary member to rotate toward the second direction.

9. A display device comprising:
a display;
a stand; and
a latching mechanism to latch the display to the stand, the latching mechanism comprising:
a base secured to the stand and comprising a first limiting surface, a second limiting surface, and a sliding slot;
a sliding member mounted to a back of the display, capable of being moved down and up along the sliding slot, and comprising a first limiting element and a second limiting element;
a rotary member comprising a first pivot, a first resisting element, and a second resisting element, wherein, the first pivot is pivotally secured to the base, the first resisting element and the second resisting element are arranged over the first pivot and angled to each other; and
an elastic member with one end pivotally secured to the base and an opposite end pivotally secured to the rotary member, wherein, the elastic member is capable of causing the rotary member to rotate toward a first direction and a second direction opposite to the first direction around the first pivot, the further rotation of the rotary member toward the first direction is prevented by the first limiting surface, and the further rotation of the rotary member toward the second direction is prevented by the second limiting surface;
wherein, when the rotary member is rotated toward the first direction to cause the first resisting element to be engaged with a bottom of the first limiting element, the latching mechanism is in a locked state, and the further rotation of the rotary member toward the first direction is prevented by the first limiting surface, the second limiting element is capable of resisting the first resisting element to cause the rotary member to rotate toward the second direction until the further rotation of the rotary member toward the second direction is prevented by the second limiting surface; the second limiting element is further capable of resisting the second resisting element to cause the rotary member to rotate toward the first direction until the first resisting element contacts the first limiting element, and until the rotary member is in a position where the elastic member causes the rotary member to rotate toward the first direction.

10. The display device as described in claim 9, wherein the sliding member further comprises a main body, the first limiting element and the second limiting element protrude from a front surface of the main body, the distance between a free end of the second limiting element and the front surface of the main body is greater than the distance between a free end of the second limiting element and the front surface of the main body.

11. The display device as described in claim 10, wherein the first limiting element and the second limiting element cooperatively form a first gap, the first limiting element includes a fixing portion and two protrusions, the fixing portion is fixed to the main body, the protrusions protrude from the fixing portion and cooperatively form a second gap, an end of the first resisting element enters the first gap via the second gap.

12. The display device as described in claim 11, wherein a hook protrudes from a bottom of the fixing portion facing the second limiting element, the free end of the first resisting member defines a latching slot to latch the hook.

13. The display device as described in claim 9, wherein the elastic member comprises a fixing element, a connecting element, and an elastic element, the fixing element comprises a second pivot and is pivotally secured to the base via the second pivot, the elastic element is arranged over the connecting element with one end resisting the fixing element and another end resisting the connecting element.

14. The display device as described in claim 13, wherein the elastic member further comprises a third pivot, the connecting element is pivotally secured to the rotary member via the third pivot, the third pivot is caused to be rotated around the first pivot.

15. The display device as described in claim 14, wherein the fixing member defines a limiting hole, one end of the connecting element is slidably received in the limiting hole.

16. The display device as described in claim 14, wherein when the third pivot is at a left side of a reference line connecting the first pivot and the second pivot, the elastic element forces the rotary member to rotate toward the first direction, and when the third pivot is at a right side of the reference line, the elastic element forces the rotary member to rotate toward the second direction.
